(19) United States
(12) Patent Application Publication
(10) Pub. No.: US 2005/0015674 A1
(43) Pub. Date: Jan. 20, 2005

(54) Method, apparatus, and program for converting, administering, and maintaining access control lists between differing filesystem types

(75) Inventor: Julianne Frances Haugh, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/611,020

(22) Filed: Jul. 1, 2003

(51) Int. Cl. H02H 3/05

(52) U.S. Cl. 714/38

(57) ABSTRACT

A portable access control list (PACL) model is provided. The PACL is not meant to represent an actual ACL instantiation, but rather a global representation of the access control list concept. A portable ACL entry includes a tuple of identifiers, permissions and/or actions, and application rules. The portable ACL model is a superset of all existing identifiers, permissions, and actions. The PACL model also is unordered; therefore, any ACL model may be represented in the PACL model. A programming model is also provided. The programming model consists of common operations performed on ACL objects and may accept PACL entry information or filesystem specific ACL entry information. A mechanism is provided for performing conversion operations between actual filesystem specific ACL models and the PACL model. The PACL model may serve as an intermediate model between disparate filesystems.

### BACKGROUND OF THE INVENTION

1. Technical Field

The present invention relates to computer filesystems and, in particular, to access control lists in computer filesystems. Still more particularly, the present invention provides a method, apparatus, and program for converting, administering, and maintaining access control lists between differing filesystem types.

2. Description of Related Art

Access Control Lists have become a common security feature in filesystems. An access control list (ACL) allows control of access to a file system object to be specified to the granularity of individual users or groups.

Early file system control mechanisms, such as those provided by the USG and BSD UNIX file systems, allowed access rights to be specified in terms of the object owner, the group associated with the object owner, and all other users who were neither the object owner nor members of the object owner's group. Each of those three entries provided a set of three permissions, read, write, and execute, with the interpretation of those permissions differing between file system objects which were directory objects and those which were not.

Extensions to that model, such as the ACL model provided by the UNIX System V Release 4 (SVR4) filesystem, allow additional user and group entries to be defined with each entry granting access to the same set of three permissions as the three base (object owner, object group, other) entries. A user or group entry is referred to as an access control entry (ACE). SVR4 enforces a rule requiring that all user-based ACEs be defined before all group-based ACEs, with the other permissions defined last.

The SVR4 ACL is evaluated in the order given, with the first matching user or group entry specifying the permissions which were granted. If no entries match the user or group values associated with the requesting process, the other permissions are used. This is an example of an “ordered” ACL.

Other ACL models, such as the ACL model provided by the AIX Version 3.1 (AIX) file system, allow additional entries to be defined with the identity portion of the entry allowing for inclusion of user and group identity information within a single entry. Access to the same set of read, write, and execute permissions can be specified in terms of granting access (permit), denying access (deny) or both granting the given permissions and denying the permissions which were not granted (specify).

No ordering rules, other than that the object owner and object group permissions are considered first, are imposed upon AIX ACLs. The AIX ACL is evaluated from beginning to end, with each matching entry used to determine the final set of access permissions. If no entries match the user or group values associated with the requesting process, the other permissions are used. This is an example of an “unordered” ACL.

The filesystem and/or ACL model may be chosen based upon preference or need. However, in a network data processing system, several disparate filesystems and ACL models may exist. The task of converting from one ACL type to another becomes critical in a network environment with heterogeneous filesystems and ACL models. However, as filesystems increase in complexity, this task becomes more difficult.

One solution to this problem is for every filesystem to use the same ACL model. The most recent attempt at creating a standard ACL interface was undertaken by the Portable Operating System Interface for UNIX (POSIX) security working group. This standard ACL model was originally known as POSIX standard 1003.6, which is now 103.1e but commonly referred to as “dot6.” When working group members were unable to reach a consensus on ACLs and many other security features, the standard was abandoned.

Interest in the POSIX ACL model has increased with the open source community with dot6 implementations on such systems as Linux and FreeBSD. Despite the attempt at creating a de facto ACL standard by embracing the defunct dot6 standard, vendors have proceeded to create ACL models which are supersets of dot6 or completely unrelated to dot6. Thus, it would appear that there may never be a standard ACL model.

Another solution in a heterogeneous network environment is to perform individual filesystem-to-filesystem conversions on ACLs. Each filesystem must be modified to perform a conversion for every other ACL model on the network. This solution is cumbersome and possibly inaccurate.

Therefore, it would be advantageous to provide an improved mechanism for converting, administering, and maintaining access control lists between differing filesystem types.

### SUMMARY OF THE INVENTION

The present invention provides a portable access control list (PACL) model. The PACL is not meant to represent an actual ACL instantiation, but rather a global representation of the access control list concept. A portable ACL entry includes a tuple of identifiers, permissions and/or actions, and application rules. The portable ACL model is a superset of all existing identifiers, permissions, and actions. The PACL model also is unordered; therefore, any ACL model may be represented in the PACL model. The present invention also provides a programming model, which consists of common operations performed on ACL objects and may accept PACL entry information or filesystem specific ACL entry information. The present invention also provides a mechanism for performing conversion operations between actual filesystem specific ACL models and the PACL model. The PACL model may serve as an intermediate model between disparate filesystems.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating a heterogeneous filesystem environment in accordance with a preferred embodiment of the present invention;

FIG. 5 is a block diagram depicting a programming model in accordance with a preferred embodiment of the present invention;

FIGS. 6A-6C are block diagrams illustrating example ACL operations in accordance with a preferred embodiment of the present invention;

FIG. 7 is a flowchart illustrating of the operation of a portable access control list programming model in accordance with a preferred embodiment of the present invention; and

FIG. 8 is a flowchart illustrating the operation of an access control list mechanism in accordance with a preferred embodiment of the present invention.

### DETAILED DESCRIPTION OF THE PREFERRED EMBODIMENT

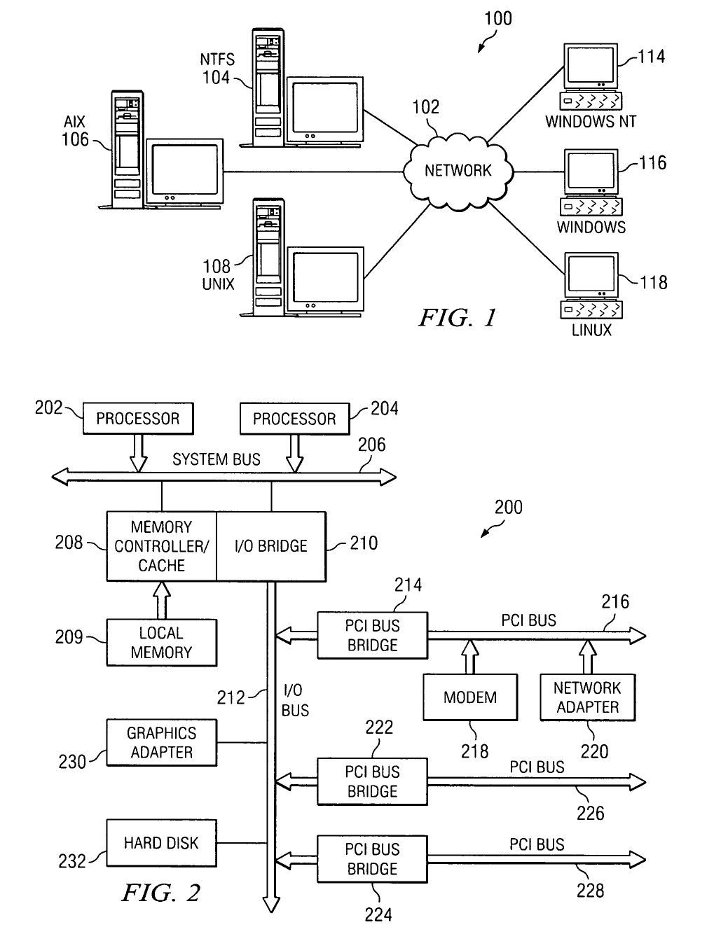

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, servers 104, 106, 108 are connected to network 102. In addition, clients 114, 116, 118 are connected to network 102. These clients 114, 116, and 118 may be, for example, personal computers or network computers. In the depicted example, servers 104, 106, and 108 provide data, such as boot files, operating system images, and applications to clients 114-118. These files are stored by the servers in a filesystem. The clients also store files in a filesystem. For example, server 104 stores files in a Windows NT™ filesystem (NTFS); server 106 stores files in an AIX file system; and, server 108 stores files in a UNIX file system, such as System V Release 4 (SVR4). Similarly, client 114 stores files in a Windows NT™ filesystem; client 116 stores files in a Windows™ based filesystem, such as FAT32; and, client 118 stores files in a Linux file system.

The disparate filesystems and, more particularly, the differing access control list (ACL) models in network data processing system 100 pose problems for filesystems. For example, client 118 may request a Linux-based file system ACL, such as a network filesystem (NFS) ACL, from server 104, which would normally provide an NTFS ACL. In accordance with a preferred embodiment of the present invention, a portable ACL (PACL) model is provided for converting, administering, and managing ACLs in a heterogeneous network environment, such as network data processing system 100 in FIG. 1.

The PACL model is not meant to represent an actual ACL instantiation, but rather a global representation of the access control list concept. That is, the PACL model is independent of any given filesystem. A portable ACL includes a tuple of identifiers, permissions and/or actions, and application rules. Identifiers may include, for example, user name, group name, requester host identification, time of day, day of week, etc. Permissions and actions may include read, write, execute, control, list, insert, delete, audit, notify administrator, create billing entry, etc. The portable ACL model is a superset of all existing identifiers, permissions, and actions. The rules define the way in which the permissions or actions are applied. For example, rules may include permit the operation, deny the operation, specify that the operations which are given are allowed and those which are not given are denied, etc.

As stated above, the PACL model is a global representation. An identifier does not have to be limited to the classic “user ID” and “group ID” concepts, but may include anything that is known about the requesting thread or the environment in which the thread is issuing the request. Permissions do not have to be limited to access decisions (e.g. “read,” “write,” “execute”), but may encompass security actions (e.g. “audit,” “notify administrator”) or non-security actions (e.g. “create billing entry”).

The concept of “application” has typically been limited to “permit,” and within AIX “deny” and “specify.” However, in the PACL model of the present invention, “application” is expanded to include concepts such as “grant subject identity” or “require subject identity.”

The present invention also provides a programming model, which consists of common operations performed on ACL objects. This programming model constitutes the basic building blocks for performing ACL operations. Higher-level application program interfaces (API) may be coded in terms of these building block routines and may accept PACL entry information or filesystem specific ACL entry information.

The present invention also provides a mechanism for performing conversion operations between actual filesystem specific ACL models and the PACL model. The PACL model may serve as an intermediate model between disparate filesystems. Rather than requiring that each filesystem vendor provides a conversion routine between their unique format and each other possible ACL, the present invention only requires that a filesystem vendor, or operating system vendor as the case may be, provide a module that is capable of converting between their own ACL model and the PACL model.

Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages.

The mechanism of the present invention may create type tagged ACL objects. However, the type of an ACL object may be determined without relying on explicit tagging. The mechanism of the present invention then selects which dynamically-loaded shared executable object is to perform a specific operation. The dynamically-loaded shared executable object may be selected by determining the type of the ACL or by the use of an explicit ACL tag.

High level operations, such as the programming APIs specified by the ACL section of dot6, are built using the lower-level operations. Each operation begins by locating the subroutine entry points associated with the type of ACL being processed. Then a fixed sequence of steps, based upon the building block operations described above are performed. In this manner, the entire collection of known functions may be implemented without the programmer having to be aware that the actual ACL format is not the PACL format.

Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM e-Server pSeries system, a product of International Business Machines Corporation in Armonk, N.Y.

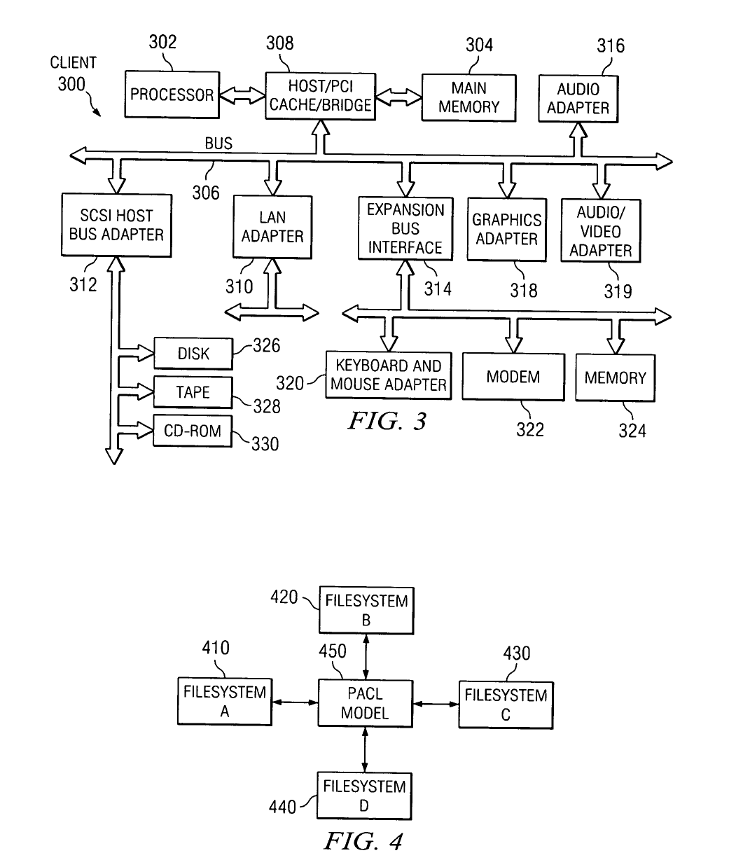

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference to FIG. 4, a block diagram illustrating a heterogeneous filesystem environment is shown in accordance with a preferred embodiment of the present invention. Filesystem A 410, filesystem B 420, filesystem C 430, and filesystem D 440 may communicate ACL entries via PACL model 450. The filesystems may exist on the same machine or may communicate through a communications medium, such as a network or dial-up connection.

Prior art conversion mechanisms perform specific mappings from one format to another. Each new ACL model requires the addition of translators between the new format and all previous formats. An environment with two ACL models requires a single translator (a<->b), an environment with three ACL models requires three translators (a<->b, a<->c, b<->c), an environment with four ACL models requires six translators (enumeration left to the reader as an exercise), and so on, increasing in a combinatorial manner. The number of required translators increases according to the number of pre-existing translators. The existing AIX environment currently has five ACL models (AIX, DFS, AFS, GPFS and VxFS) with a six-ACL model, NFSv4, being planned. Support for that environment alone would require a total of fifteen translators. Future additions will require increasingly large numbers of translators be written to perform the mapping between ACL models.

The mechanism of the present invention removes the need for multiple translators per ACL model by defining an interlingua which serves as a super-set ACL language. An interlingua is an artificial language, which serves as a medium for communicating between different languages. In this instance, the languages are access rights and associated semantics. Other uses of intermediate languages include languages generated by the intermediate stages of program compilation, or artificial languages generated by compilers so that multiple compiler front ends may produce code to the same language which is then translated into actual machine code by a platform-specific code generator. For more information, see A Portable Compiler: Theory and Practice, S. C. Johnson, Fifth ACM Symposium: Principles of Programming Languages.

The PACL model is a global representation of all ACL models. The PACL model of the present invention is independent of any given filesystem. Translation into the superset language, or PACL, must maintain the semantics of the original ACL model. Translation from the superset language, or PACL, infers the correct semantics for the target ACL model from the well-known semantics of the PACL language. The richness of the defined PACL language determines the correctness of the translations which are capable using this mechanism.

Ordered ACL models are interpreted such that an earlier matching ACE excludes one or more subsequent matching ACEs from participating in the access decision. Unordered ACLs models are interpreted such that each matching ACE participates in the access decision. The intermediate ACL format is unordered as entries may be added to an unordered ACL to restrict interpretation of subsequent ACEs. The use of an ordered ACL model for the intermediate format would require that all possible evaluations of the ACL, of which there is a potentially infinite number, be considered at translation time.

Translation from ordered to unordered may be performed by expanding each ordered ACE into one or more ACEs. The source ACE is converted into an ACE which grants the permissions specified by the source ACE and a second ACE which denies the permissions which were not granted. The result, in an unordered ACL, is that no subsequent ACE may grant permissions which were not granted by the earlier ACE. This is a common transformation and is described in the intermediate format through the use of a “specify” ACE type.

For example, an ACE which grants members of group_{—}1 read and write permission will be converted into two ACEs, one which grants read and write permissions to group_{—}1, followed by one which denies execute permission to group_{—}1.

Translation from unordered to ordered may be performed by sorting ACEs such that the most permissive and least specific ACEs (those which grant the greatest permissions and affect the largest number of users) are placed before the least permissive and most specific ACEs (those which grant the fewest permissions and affect the smallest number of users). The result, in an ordered ACL, is that an ACE which terminates the access decision is more likely to have granted the largest possible set of permissions without restricting any permission that would have been granted in an unordered evaluation of the ACL.

For example, an ACE which grants read and write permission to members of group_{—}1 will occur before an ACE which grants only read permission to members of group_{—}2. In this example, a process with membership in both group_{—}1 and group_{—}2 is granted read and write permission by the first ACE and membership in group_{—}1, whereas the opposite ordering would have needlessly denied write permission based on the second ACE and membership in group_{—}2.

The two ACL types described thus far limit the set of permissions to a very small set, namely read, write, and execute permissions. Newer ACL models, such as those provided by the Distributed File System (DFS) and the Windows NT™ File System (NTFS), provide finer granularity for specifying permissions. The intermediate format must define a set of permissions which encompasses the semantics of the ACL permissions for all models which may be translated. The extensions to the basic permissions defined by the SVR4 and AIX commonly include the following:
Creation of a new object within a directory;
Deletion of an object within a directory;
Listing the objects within a directory;
Performing administrative actions on an object;
Modifying the non-access related attributes of an object;
Modifying the access related attributes of an object;
Appending data to an existing object.

Translations from less specific models to more specific models capture the permission semantics by expanding permissions. Translations from more specific models to less specific models capture the permission semantics by verifying that all required permissions are present before granting a permission type, or denying a permission type, if one or more required permissions are missing.

The DFS and NTFS ACL models define a variety of additional permissions. The DFS ACL model includes a total of six permissions, read, write, execute, control, insert, and delete. The NTFS model defines even more permissions, providing the ability to specify the right to modify non-permission, non-data aspects of a file.

Several existing ACL models, such as SVR4 and DFS, provide mechanisms which do not directly control access decisions, but rather these mechanisms modify the way in which other entries are interpreted. The most common form of entry is a mask entry. The mask entry is typically used to limit the permissions which an ACE may grant to a process. For example, the following DFS ACE restricts other ACEs to granting read permission, regardless of the actual permissions contained in the ACE:
mask_obj:r-----
   The intermediate ACL provides support for ACE masking by defining a mask ACE type. Non-permission entries involve translation time modifications to the existing ACE.

The AIX ACL format does not provide support for mask ACEs. The SVR4 ACL format requires that a mask ACE be present. Translation from the intermediate format to the AIX format will involve removing any permission contained within an option mask ACE prior to actual translation. Translation from the intermediate format to the SVR4 format requires that a mask ACE be added after translation and that the mask ACE include all of the permissions which are contained in any of the non-object owner ACEs.

The rules for converting non-permission ACEs vary between filesystems. Each translation function is responsible for properly conveying the semantics of the non-permission entry when converting to the intermediate format, and for recreating the semantics of the non-permission entry when converting from the intermediate format.

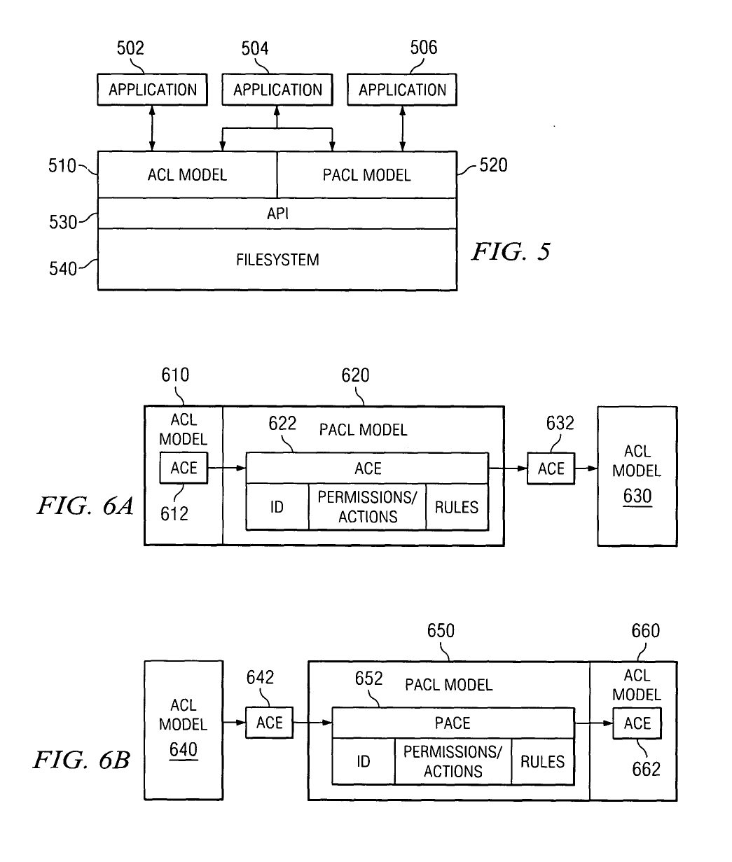

With reference to FIG. 5, a block diagram depicting a programming model is shown in accordance with a preferred embodiment of the present invention. Applications 502, 504, 506 access filesystem 540 through application program interface (API) 530. The present invention provides a programming interface, which consists of common operations performed on ACL objects. This programming model constitutes the basic building blocks for performing ACL operations. Higher-level application program interfaces (API) may be coded in terms of these building block routines and may accept PACL entry information or filesystem specific ACL entry information.

Application 502 accesses API 530 through the filesystem specific ACL model 510. Application 506 accesses API 530 through the PACL model 520. Application 504 accesses API 530 using both the filesystem specific ACL model 510 and the PACL model 520.

Portable Module API Set:

The function entry points defined for the model can be divided into a small number of categories. Those categories are as follows:
ACL storage and retrieval;
ACL and ACE conversion;
ACL and ACE initialization;
ACE query and modification;
ACL administration.

There are four ACL storage and retrieval functions corresponding to the two different ways which a filesystem object can be referenced, by name and by open file descriptor. The primary goal of these functions is separating the act of storing and retrieving ACLs from the underlying system calls or mechanisms.

The ACL and ACE conversion functions fulfill two different requirements. ACL conversion has the goal of converting ACLs from one type to another type, whereas ACE conversion has the goal of allowing ACEs to be constructed and deconstructed in a portable manner, allowing applications to portably construct or examine ACLs a single entry at a time.

The ACL and ACE initialization functions allow entire ACLs and ACEs to be constructed. ACEs which are constructed by the ACE initialization functions may be used to search or update an existing ACL. The ACE query and modification functions allow ACE level operations to be performed on an ACL. The operations allow ACEs to be added, deleted, modified, or queried. The ACL administration functions perform administration functions, such as, for example, “mask” and “validate” functions.

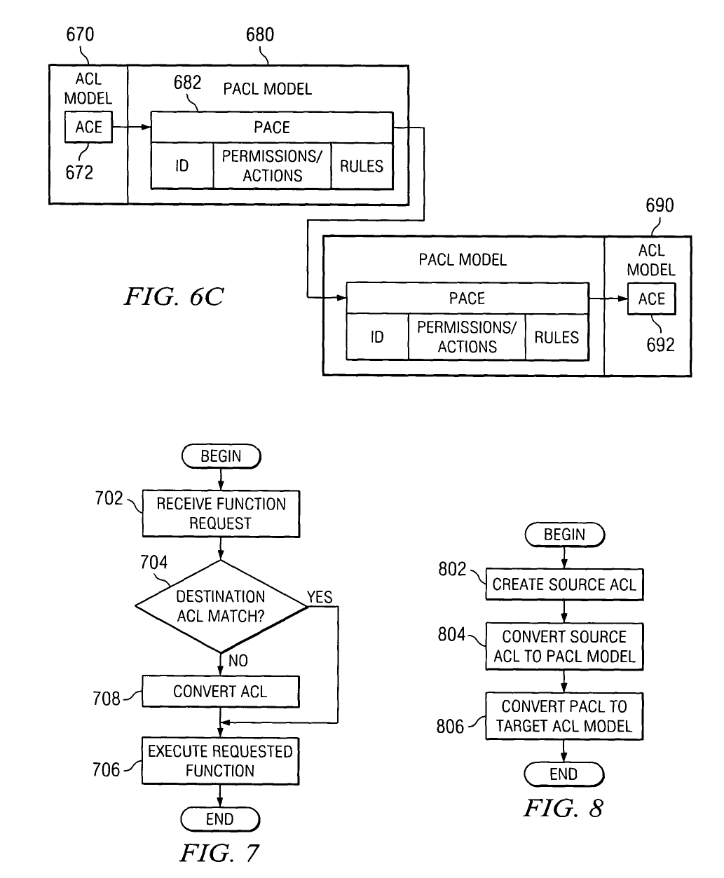

With reference now to FIGS. 6A-6C, block diagrams illustrating example ACL operations are shown in accordance with a preferred embodiment of the present invention. More particularly, with reference to FIG. 6A, ACL model 610 provides an access control entry (ACE) to ACL model 630. ACE 612 is created in ACL model 610. The ACE is converted to PACL model 620 to form PACE 622 and transferred to the machine having ACL model 630. PACE 622 is a tuple of IDs, permissions and/or actions, and rules, as described above. PACE 622 is then converted to ACE 632, which is specific to ACL model 630.

The operation shown in FIG. 6A is performed when a machine having ACL model 610 provides an ACE to a machine having ACL model 630. The machine having ACL model 610 may put or insert the ACE to the machine having ACL model 630. Alternatively, the machine having ACL model 630 may request the ACE from the machine having ACL model 610.

With reference to FIG. 6B, ACL model 640 provides an access control entry (ACE) to ACL model 660. ACE 642 is created in ACL model 640. The ACE is transferred to the machine having ACL model 660 and converted to PACL model 650 to form PACE 652. The PACE is a tuple of IDs, permissions and/or actions, and rules, as described above. PACE 652 is then converted to ACE 662, which is specific to ACL model 660.

The operation shown in FIG. 6B is performed when a machine having ACL model 640 provides an ACE to a machine having ACL model 660. The machine having ACL model 640 may put or insert the ACE to the machine having ACL model 660. Alternatively, the machine having ACL model 660 may request the ACE from the machine having ACL model 640.

Turning now to FIG. 6C, ACL model 670 provides an access control entry (ACE) to ACL model 690. ACE 672 is created in ACL model 670. The ACE is converted to PACL model 680 to form PACE 682. The PACE is a tuple of IDs, permissions and/or actions, and rules, as described above. PACE 682 is then transferred to the machine having ACL model 660 and converted from the PACL model to ACE 692, which is specific to ACL model 690.

The operation shown in FIG. 6C is performed when a machine having ACL model 670 provides an ACE to a machine having ACL model 690. The machine having ACL model 670 may put or insert the ACE to the machine having ACL model 690. Alternatively, the machine having ACL model 690 may request the ACE from the machine having ACL model 670.

### CONVERSION EXAMPLES

A preferred embodiment of the PACL format is an intersection of the AIX ACL model's access specification rules with the NTFS permissions. The PACL format may be expanded as required to provide additional support for more complex ACL models. The basic concept of converting from the source ACL format into the PACL format, and then from the PACL format to the destination format remains the same.

### SVR4 to AIX Conversion Example

1. SVR4 to PACL Conversion

The SVR4 ACL model provides a simple ordered ACL model with six ACE types. This is a common model within the industry and is used in such diverse products as the Veritas VxFS filesystem, IBM's GPFS filesystem and the native UNIX System V Release 4 filesystem.

An unextended ACL, also known as a “base ACL” or “permission bits only ACL,” contains four entries. Those entries are USER_OBJ, GROUP_OBJ, CLASS_OBJ, and OTHER_OBJ. Extended ACLs include entries for USER and GROUP. Additional “default” ACL entries may also be defined, but are being ignored for the sake of this example. Conversion of default ACL entries is similar to the conversion of effective ACL entries. The following example shows a SVR4 “base ACL” which grants read, write, and execute permission to the file owner, read and execute permission to the file group, and execute only permission to all other users. The “permission bits” representation would be “rwxr-x--x”, or octal mode 0751.
User::rwx
Group::r-x
Other::--x
Mask::r-x
   The value of the mask entry is the same as the value of the GROUP_OBJ ACE. An extended ACL may contain one or more GROUP or USER entries, as shown in the following example which grants read and execute permission to members of the group “project.”
User::rwx
Group::r-x
Other::--x
Mask::r-x
Group:project:r-x
   The first translation step is capturing the correct ordering of the ACL as it is actually evaluated. The SVR4 ACL is evaluated as follows:
USER_OBJ entry applies if effective UID matches file owner ID;
CLASS_OBJ entry restricts any entries which come afterward, except for the OTHER_OBJ entry;
Any USER entries apply if effective UID matches the UID in the USER entry;
GROUP_OBJ entry applies if the effective GID, or any GID in the concurrent group set matches the file group ID;
Any GROUP entries apply if the effective GID, or any GID in the concurrent group set matches the file group ID;
OTHER_OBJ entry applies if no earlier entries applied.
   The ACL is now written as follows:
User::rwx
Mask::r-x
Group::r-x
Group:project:r-x
Other::r--

No change in semantics has occurred by this reordering. The ACL is now converted into PACL format. The first field represents the identity of the user or group which must match the ACE in order for the ACE to apply. The second field represents the way in which the permissions which follow will be applied. In this instance, the SVR4 model is such that the permissions of the matching ACE are the specific permissions granted by the ACE, so SPECIFY is used rather than PERMIT or DENY. The remaining entries are the expanded permissions associated with the actual SVR4 permission bits.

| | |
|---|---|
| PACL_USER_OBJECT | SPECIFY |

```
    READ_DIR, READ_DATA, WRITE_DATA, APPEND_DATA,
    CREATE_OBJECT, DELETE_OBJECT, EXECUTE_OBJECT,
    LOOKUP_DIR, CONTROL_OBJECT
```

| | |
|---|---|
| PACL_MASK | SPECIFY |

```
    READ_DIR, READ_DATA, EXECUTE_OBJECT,
    LOOKUP_DIR
```

| | |
|---|---|
| PACL_GROUP_OBJECT | SPECIFY |

```
    READ_DIR, READ_DATA, EXECUTE_OBJECT,
    LOOKUP_DIR
```

| | |
|---|---|
| PACL_GROUP(project) | SPECIFY |

```
    READ_DIR, READ_DATA, EXECUTE_OBJECT,
    LOOKUP_DIR
```

| | |
|---|---|
| PACL_OTHER | SPECIFY |

READ_DIR, READ_DATA

This ACL captures the semantics of the original ACL without any loss of security. The only loss of precision occurs because the PACL format is unordered and the original format is ordered.
2. PACL to AIX Conversion

The above PACL will be used to demonstrate how a PACL is converted into a target format.

| | |
|---|---|
| PACL_USER_OBJECT | SPECIFY |

```
    READ_DIR, READ_DATA, WRITE_DATA, APPEND_DATA,
    CREATE_OBJECT, DELETE_OBJECT, EXECUTE_OBJECT,
    LOOKUP_DIR, CONTROL_OBJECT
```

| | |
|---|---|
| PACL_MASK | SPECIFY |

```
    READ_DIR, READ_DATA, EXECUTE_OBJECT,
    LOOKUP_DIR
```

| | |
|---|---|
| PACL_GROUP_OBJECT | SPECIFY |

```
    READ_DIR, READ_DATA, EXECUTE_OBJECT,
    LOOKUP_DIR
```

| | |
|---|---|
| PACL_GROUP(project) | SPECIFY |

```
    READ_DIR, READ_DATA, EXECUTE_OBJECT,
    LOOKUP_DIR
```

| | |
|---|---|
| PACL_OTHER | SPECIFY |

READ_DIR, READ_DATA

The AIX ACL does not support a mask object, so the mask object is applied to all entries in the ACL. (Conveniently the mask in this example does not change any permissions). Next, the entries are sorted into the correct native order, with the “base ACL” entries appearing before any extended ACL entries. Although they appear in a different ordering, the evaluation order is the same as what is given in the earlier PACL.

| | |
|---|---|
| PACL_USER_OBJECT | SPECIFY |

```
    READ_DIR, READ_DATA, WRITE_DATA, APPEND_DATA,
    CREATE_OBJECT, DELETE_OBJECT, EXECUTE_OBJECT,
    LOOKUP_DIR, CONTROL_OBJECT
```

| | |
|---|---|
| PACL_GROUP_OBJECT | SPECIFY |

```
    READ_DIR, READ_DATA, EXECUTE_OBJECT,
    LOOKUP_DIR
```

| | |
|---|---|
| PACL_OTHER | SPECIFY |

READ_DIR, READ_DATA

| | |
|---|---|
| PACL_GROUP(project) | SPECIFY |

```
    READ_DIR, READ_DATA, EXECUTE_OBJECT,
    LOOKUP_DIR
```

Redundant information, such as the PACL_USER_OBJECT entry having SPECIFY as the permission type and a CONTROL_OBJECT entry, is removed and identifiers are converted to their AIX format.

```
attributes:
base permissions
    owner(%u):
    READ_DIR, READ_DATA, WRITE_DATA, APPEND_DATA,
    CREATE_OBJECT, DELETE_OBJECT, EXECUTE_OBJECT,
    LOOKUP_DIR
    group(%g):
    READ_DIR, READ_DATA, EXECUTE_OBJECT,
    LOOKUP_DIR
    others:
    READ_DIR, READ_DATA
extended permissions
    enabled
    specify READ_DIR, READ_DATA, EXECUTE_OBJECT,
    LOOKUP_DIR g:project
```

Finally, the permissions are converted from their PACL forms to the AIX forms. Conversion requires that an ACE have either READ_DATA or READ_DIR permission in order to have read permission, all of either the directory related or file related attributes in WRITE_DATA, WRITE_DIR, APPEND_DATA, CREATE_OBJECT, and DELETE_OBJECT in order to have write permission, and EXECUTE_OBJECT or LOOKUP_DIR in order to have execute permission. So the permissions are now converted according to the above rules leaving the final ACL. Note that the (% u) and (% g) tokens are used to indicate that the file user ID (% u) and file group ID (% g) are implied in these entries.

```
attributes:
base permissions
    owner(%u): rwx
    group(%g): r-x
    others:  r--
extended permissions
    enabled
    specify r-x g:project
```

Note that the specify group entry accurately reflects the ordered nature of the original SVR4 ACL. Had additional ACEs been present each of those ACEs would likewise have been translated to a specify entry, thereby preventing the AIX unordered evaluation from granting additional permissions.

### AIX to NFSv4 Conversion Example

The AIX ACL model has features which are not present in the NFSv4 model, such as the ability to create specify entries which are the equivalent of a permit entry and a deny entry. The PACL format is capable of preserving the specify semantics, so the conversion issue is moved from the AIX translator to the NFSv4 translator. One advantage of the modular approach to translation becomes apparent when considering that SVR4 has implicit specify entries due to its ordered nature.

1. AIX to PACL Conversion

The ACL for this example will show the difference in the decision making process.

```
Attributes:
Base permissions
    Owner(carl): rw-
    Group(nfs): r-x
    Others: r--
Extended permissions
    Enabled
    Permit  r-x u:julie
    Deny  rwx g:nfs,g:j2
    Specify  rw- u:dave
    Permit  --x u:joe,g:test
```

The initial conversion is fairly straightforward, although one problem becomes readily apparent. The deny entry contains two group identifiers, and the PACL format does not have any corresponding object. The last permit entry contains both a user and a group identifier which is supported by the PACL format. It will be up to the target translator to map that entry. Also, the AIX format is unordered with deny and the restrictive part of specify ACEs applying even if a later permit or permissive part of specify ACEs grant the permissions. Thus, all restrictions are sorted before all permissions within any section of the ACL giving a final order of deny, specify, permit. The PACL conversion thus becomes the following:

| | |
|---|---|
| PACL_USER_OBJECT | SPECIFY |

```
    READ_DIR, READ_DATA, WRITE_DATA, APPEND_DATA,
    CREATE_OBJECT, DELETE_OBJECT, CONTROL_OBJECT
```

| | |
|---|---|
| PACL_GROUP_OBJECT | PERMIT |

```
    READ_DIR, READ_DATA, EXECUTE_OBJECT,
    LOOKUP_DIR
```

| | |
|---|---|
| PACL_GROUP(nfs) | DENY |

```
    READ_DIR, READ_DATA, WRITE_DATA, APPEND_DATA,
    CREATE_OBJECT, DELETE_OBJECT, EXECUTE_OBJECT,
    LOOKUP_DIR, CONTROL_OBJECT
```

| | |
|---|---|
| PACL_GROUP(j2) | DENY |

```
    READ_DIR, READ_DATA, WRITE_DATA, APPEND_DATA,
    CREATE_OBJECT, DELETE_OBJECT, EXECUTE_OBJECT,
    LOOKUP_DIR, CONTROL_OBJECT
```

| | |
|---|---|
| PACL_USER(dave) | SPECIFY |

```
    READ_DIR, READ_DATA, WRITE_DATA, APPEND_DATA,
    CREATE_OBJECT, DELETE_OBJECT
```

| | |
|---|---|
| PACL_USER(julie) | PERMIT |

```
    READ_DIR, READ_DATA, EXECUTE_OBJECT,
    LOOKUP_DIR
```

| | |
|---|---|
| PACL_USERGRP(joe,test) | PERMIT |

EXECUTE_OBJECT, LOOKUP_DIR

| | |
|---|---|
| PACL_OTHER_OBJECT | PERMIT |

READ_DIR, READ_DATA

Note the expansion of the “deny rwx g:nfs,g:j2” to a pair of deny entries. This is required as discarding either entry would result in a process with membership in both groups being granted access in the event the file group was modified.
2. PACL to NFSv4 Conversion

The conversion from PACL format to NFSv4 format is likewise fairly straightforward. Because the PACL format is inherently unordered, as a result of having captured virtually all of the semantics of the source ACL, entries can be expanded, translated and rearranged according to the semantic rules for ACL translation of the destination ACL type.

NFSv4, despite its richness in terms of permissions, lacks a specify ACE type. What it provides instead are ALLOWED and DENIED type entries. So the PACL above is translated into the following intermediate form prior to conversion to the final NFSv4 ACL by splitting the specify ACEs into a deny entry and a permit entry. The ACE which contains a user and a group who in the same ACE is split into two restrictive ACEs. An earlier ACE may have granted permissions which neither the user nor the group can be allowed to have in the event the process has both user and group at the same time. Furthermore, NFSv4 has an “EVERYONE@” entry which includes not only the file owner and group, but also every ACE in the ACL. This requires that deny ACEs be added immediately before the other ACE.

| | |
|---|---|
| PACL_USER_OBJECT | DENY |

EXECUTE_OBJECT, LOOKUP_DIR

| | |
|---|---|
| PACL_USER_OBJECT | PERMIT |

```
    READ_DIR, READ_DATA, WRITE_DATA, APPEND_DATA,
    CREATE_OBJECT, DELETE_OBJECT, CONTROL_OBJECT
```

| | |
|---|---|
| PACL_GROUP_OBJECT | PERMIT |

```
    READ_DIR, READ_DATA, EXECUTE_OBJECT,
    LOOKUP_DIR
```

| | |
|---|---|
| PACL_GROUP(nfs) | DENY |

```
    READ_DIR, READ_DATA, WRITE_DATA, APPEND_DATA,
    CREATE_OBJECT, DELETE_OBJECT, EXECUTE_OBJECT,
    LOOKUP_DIR, CONTROL_OBJECT
```

| | |
|---|---|
| PACL_GROUP(j2) | DENY |

```
    READ_DIR, READ_DATA, WRITE_DATA, APPEND_DATA,
    CREATE_OBJECT, DELETE_OBJECT, EXECUTE_OBJECT,
    LOOKUP_DIR, CONTROL_OBJECT
```

| | |
|---|---|
| PACL_USER(dave) | DENY |

EXECUTE_OBJECT, LOOKUP_DIR, CONTROL_OBJECT

| | |
|---|---|
| PACL_USER(dave) | PERMIT |

```
    READ_DIR, READ_DATA, WRITE_DATA, APPEND_DATA,
    CREATE_OBJECT, DELETE_OBJECT
```

| | |
|---|---|
| PACL_USER(julie) | PERMIT |

```
    READ_DIR, READ_DATA, EXECUTE_OBJECT,
    LOOKUP_DIR
```

| | |
|---|---|
| PACL_USER(joe) | DENY |

```
    READ_DIR, READ_DATA, WRITE_DATA, APPEND_DATA,
    CREATE_OBJECT, DELETE_OBJECT, CONTROL_OBJECT
```

| | |
|---|---|
| PACL_GROUP(test) | DENY |

```
    READ_DIR, READ_DATA, WRITE_DATA, APPEND_DATA,
    CREATE_OBJECT, DELETE_OBJECT, CONTROL_OBJECT
```

| | |
|---|---|
| PACL_OTHER_OBJECT | PERMIT |

READ_DIR, READ_DATA

The final step is mapping the PACL ACEs to NFSv4 ACEs.

| | |
|---|---|
| DENY | EXECUTE “OWNER@” |
| ALLOW | LIST_DIRECTORY, READ_DATA, |

```
    WRITE_DATA, APPEND_DATA, ADD_FILE,
    ADD_SUBDIRECTORY, DELETE_CHILD, READ_ACL,
    WRITE_ACL, READ_ATTRIBUTES, WRITE_ATTRIBUTES,
    READ_NAMED_ATTRS, WRITE_NAMED_ATTRS
```

| | |
|---|---|
| | “OWNER@” |
| ALLOW | LIST_DIRECTORY, READ_DATA, EXECUTE |
| | “GROUP@” |
| DENY | LIST_DIRECTORY, READ_DATA, WRITE_DATA, |

```
    APPEND_DATA, ADD_FILE, ADD_SUBDIRECTORY,
    DELETE_CHILD, EXECUTE, READ_ACL, WRITE_ACL,
    READ_ATTRIBUTES, WRITE_ATTRIBUTES,
    READ_NAMED_ATTRS, WRITE_NAMED_ATTRS
```

| | |
|---|---|
| | GROUP:“nfs” |
| DENY | LIST_DIRECTORY, READ_DATA, WRITE_DATA, |

```
    APPEND_DATA, ADD_FILE, ADD_SUBDIRECTORY,
    DELETE_CHILD, EXECUTE, READ_ACL, WRITE_ACL,
    READ_ATTRIBUTES, WRITE_ATTRIBUTES,
    READ_NAMED_ATTRS, WRITE_NAMED_ATTRS
```

| | |
|---|---|
| | GROUP:“j2” |
| DENY | EXECUTE, READ_ACL, WRITE_ACL, EXECUTE, |

```
    READ_ATTRIBUTES, WRITE_ATTRIBUTES,
    READ_NAMED_ATTRS, WRITE_NAMED_ATTRSUSER:
    “dave”
```

| | |
|---|---|
| ALLOW | LIST_DIRECTORY, READ_DATA, |

```
    WRITE_DATA, APPEND_DATA, ADD_FILE,
    ADD_SUBDIRECTORY, DELETE_CHILDUSER:“dave”
```

| | |
|---|---|
| ALLOW | LIST_DIRECTORY, READ_DATA, EXECUTE |
| | USER:“julie” |
| DENY | { } USER:“joe” |
| DENY | { } GROUP:“test” |
| DENY | LIST_DIRECTORY, READ_DATA, WRITE_DATA, |

```
    APPEND_DATA, ADD_FILE, ADD_SUBDIRECTORY,
    DELETE_CHILD USER:“dave”
```

| | |
|---|---|
| DENY | LIST_DIRECTORY, READ_DATA, EXECUTE |
| | USER:“julie” |
| ALLOW | LIST_DIRECTORY, READ_DATA |
| | “EVERYONE@” |

This result is not a particular pleasant looking ACL, but it does capture the general idea of what can be performed given the limitations of the target ACL set.

Much automatic cleaning can be performed, rearranging DENY entries, merging entries, and the like. The advantage of this mechanism is that this rearranging is done using the rules of the target ACL and is divorced from the source ACL format.

Conversion Considerations

ACL conversions can serve two different purposes and should be performed with two different objectives in mind. In the first instance, the purpose is migration of an ACL from one model to another. The objective here is to preserve the access rights without granting any access rights not granted by the original ACL. In the second instance, the purpose is displaying an ACL in one model as an ACL in another model. The objective here is to show all of the access being granted without discarding access rights which might be granted.

Migration of an ACL should always be performed using strict conversion rules. In the above examples, the UNIX write permission was mapped into a large number of PACL write-related permissions. When converting the PACL into a target format, such as the NTFS model, each of those large number of permissions map into fine-grained NTFS permissions. The reverse conversion, from an NTFS model to a UNIX model, must require that all of the PACL write-related permissions are present before granting write access. The danger is that a less permission, such as the write to add a file or subdirectory to a directory, which appear as the “Create Files” and “Create Folder” permissions, would be converted to write access, thereby allowing not only that files or subdirectories be created, but also files or subdirectories be deleted.

Display of an ACL should always be performed using lenient conversion rules. As was explained in the preceding paragraph, permissions must be discarded when mapping from one model to another if the target model lacks the granularity of the source. Displaying an ACL requires that the permissions not be discarded so that the viewer is aware of what potential permissions exist. Again, using an NTFS ACL example, an object which has “Create Files” permission must be displayed as having the UNIX write permission as it is possible to modify that object.

These differences in conversion rules require that the conversion engine be able to select for strict or lenient conversions. Under the rules for strict conversion, no permission which is not granted in the source ACL may be granted in the destination ACL, even if the original permission must be discarded. Under the rules for lenient conversion, no permission which is granted in the source ACL may be absent in the destination ACL, even if additional permissions are granted as a result. What must be kept in mind is that conversions for display purposes are not suitable for migration and vice versa.

Discarding permissions, when it must be performed, must not discard the ACE. That is, an ACE which contains no permissions must not be removed. ACL models frequently use ACE matching to make decisions about overall permissions. In the SVR4 model the first matching ACE defines the overall permissions. In the AIX model, a matching ACE indicates that the other permissions are not to be used. In both of these models discarding an empty ACE would result in an incorrect translation.

With reference now to FIG. 7, a flowchart is shown illustrating of the operation of a portable access control list programming model in accordance with a preferred embodiment of the present invention. The process begins and receives a function request (step 702). A determination is made as to whether the ACL model in the method call matches the destination ACL model (step 704). If the destination ACL model matches, the process executes the requested function (step 706) and ends. If the destination ACL model does not match in step 704, the process converts the ACL (step 708) and continues to step 706 to execute the requested function. Thereafter, the process ends.

FIG. 8 is a flowchart illustrating the operation of an access control list mechanism in accordance with a preferred embodiment of the present invention. The process begins and creates a source access control list (step 802). Then, the process converts the source ACL to the PACL model (step 804). Thereafter, the process converts the PACL to the target ACL model (step 806) and ends.

Thus, the present invention solves the disadvantages of the prior art by providing a portable access control list model. The PACL is not meant to represent an actual ACL instantiation, but rather a global representation of the access control list concept. The portable ACL model is a superset of all existing identifiers, permissions, and actions. As such, the PACL model is a global representation of all filesystems that is independent of any given filesystem.

The PACL model also is unordered; therefore, any ACL model may be represented in the PACL model. The present invention also provides a programming model, which consists of common operations performed on ACL objects and may accept PACL entry information or filesystem specific ACL entry information. The present invention also provides a mechanism for performing conversion operations between actual filesystem specific ACL models and the PACL model. In fact, the present invention may even perform conversions for ACL models that are not associated with a real-world filesystem. Thus, a developer is not stuck with pre-existing ACL models. A developer may create an ACL model with necessary, preferred, or desired properties without having to worry about the actual implementation. The PACL model serves as an intermediate model between any source model and the target ACL model associated with the target filesystem.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for converting access control lists, the method comprising:
creating a source access control list using a source access control list model; and
converting the source access control list to a portable access control list model to form a portable access control list, wherein the portable access control list model is independent of any given filesystem.

2. The method of claim 1, further comprising:
converting the portable access control list to a target access control list model to form a target access control list.

3. The method of claim 2, further comprising:
performing an operation on the target access control list.

4. The method of claim 3, wherein the operation includes placing the target access control list in a target filesystem.

5. The method of claim 1, further comprising:
performing a function on the portable access control list.

6. The method of claim 1, wherein the portable access control list includes at least a first portable access control entry.

7. The method of claim 6, wherein the first portable access control entry includes at least one identifier, at least one permission or action, and at least one rule.

8. The method of claim 7, wherein the at least one identifier includes at least one of a user name, a group name, a requestor host identification, a time of day, and a day of week.

9. The method of claim 7, wherein the at least one permission or action includes at least one of read, write, execute, control, list, insert, delete, audit, notify administrator, and create billing entry.

10. The method of claim 7, wherein the at least one rule includes at least one of permit an operation, deny an operation, and specify that operations which are given are allowed and those which are not given are denied.

11. The method of claim 1, wherein the portable access control list model is a superset of all existing identifiers, permissions, and actions.

12. The method of claim 1, wherein the portable access control list model is unordered.

13. An apparatus for converting access control lists, the apparatus comprising:
means for creating a source access control list using a source access control list model; and
means for converting the source access control list to a portable access control list model to form a portable access control list, wherein the portable access control list model is independent of any given filesystem.

14. The apparatus of claim 13, further comprising:
means for converting the portable access control list to a target access control list model to form a target access control list.

15. The apparatus of claim 13, wherein the portable access control list model is a superset of all existing identifiers, permissions, and actions.

16. The apparatus of claim 13, wherein the portable access control list model is unordered.

17. A data processing system, comprising:
a first application;
a filesystem having a target access control list model;
a programming interface, wherein the programming interface is configured to perform actions on access control lists in the target access control list model, a portable access control list model, and at least a first source access control list model different from the target access control list model, wherein the portable access control list model is independent of any given filesystem.

18 The data processing system of claim 17, wherein the programming interface receives a function request having an access control list in the first source access control list model from the application, converts the access control list to the portable access control list model to form a portable access control list, and converts the portable access control list to the target access control list model to form a target access control list.

19. The data processing system of claim 18, wherein the programming interface performs an operation on the target access control list.

20. The data processing system of claim 19, wherein the operation includes placing the target access control list in a target filesystem.

21. The data processing system of claim 17, wherein the programming interface receives a function request having a portable access control list in the portable access control list model from the application and converts the portable access control list to the target access control list model to form a target access control list.

22. The data processing system of claim 21, wherein the programming interface performs an operation on the target access control list.

23. The data processing system of claim 22, wherein the operation includes placing the target access control list in a target filesystem.

24. The data processing system of claim 17, wherein the programming interface includes functions for access control list storage and retrieval, functions for access control list and access control entry conversion, functions for access control list and access control entry initialization, functions for access control entry query and modification, and functions for access control list administration.

25. A computer program product, in a computer readable medium, for converting access control lists, the computer program product comprising:
instructions for creating a source access control list using a source access control list model; and
instructions for converting the source access control list to a portable access control list model to form a portable access control list, wherein the portable access control list model is independent of any given filesystem.

26. The computer program product of claim 25, further comprising:
instructions for converting the portable access control list to a target access control list model to form a target access control list.

27. The computer program product of claim 25, wherein the portable access control list model is a superset of all existing identifiers, permissions, and actions.

28. The computer program product of claim 25, wherein the portable access control list model is unordered.
